(19) United States
(12) Patent Application Publication
(10) Pub. No.: US 2025/0269566 A1
(43) Pub. Date: Aug. 28, 2025

(54) RESIN MOLDED PRODUCT, MOLD, METHOD OF MANUFACTURING RESIN MOLDED PRODUCT, CAMERA, AND PRINTER

(71) Applicant: CANON KABUSHIKI KAISHA, Tokyo (JP)

(72) Inventor: KEI OIKAWA, Kanagawa (JP)

(21) Appl. No.: 19/058,887

(22) Filed: Feb. 20, 2025

(30) Foreign Application Priority Data
Feb. 26, 2024 (JP) 2024-026812
Dec. 12, 2024 (JP) 2024-217433

(51) Int. Cl. B29C 33/42; B29L 31/00

(52) U.S. Cl. CPC B29C 33/424; B29K 2995/002; B29K 2995/003; B29K 2995/0074; B29L 2031/764; B29L 2031/767

(57) ABSTRACT

Disclosed are a resin molded product and method for diverse product design to provide a luxurious outer surface with deep black color, with a resin molded product that achieves luxurious colors without coating. The resin molded product includes a plurality of convex parts in a predetermined area with a height of each of the plurality of convex parts between 2 μm and 15 μm, and an arithmetic mean height of high-frequency components in the predetermined area between 12 nm and 20 nm.

### BACKGROUND

### Field

The present disclosure relates to a resin molded product, a mold, a method of manufacturing the resin molded product, a camera, and a printer.

### Description of the Related Art

An appearance surface of a resin part used for a housing, an outer shell, and the like of various products including an electronic apparatus such as a digital camera or a printer is required to have high-quality design. For example, a mirror surface like gloss can be imparted to a surface of a part by smoothing the surface of the part, thereby providing a glossy appearance. In contrast, a non-glossy texture can be imparted by providing a fine concave-convex pattern that is visually unrecognizable on the surface of the part.

To improve a texture of an appearance surface of a resin product or to impart high-quality design, a method of coating an appearance surface of a molded product has been performed. However, the coating is applied to individual molded products. Therefore, the coating is not necessarily suitable for mass production in terms of uniformity, variation, man-hour, productivity, cost, and the like.

Therefore, it has been attempted to devise a molding surface of a mold for resin molding to improve the texture of the appearance surface by resin molding without having to coat the surface of the molded product.

For example, Japanese Patent Application Laid-Open No. H9-314569 discusses a method of manufacturing a mold for obtaining an embossed product improved in designability and scratch resistance.

### SUMMARY

According to an aspect of the present disclosure, a resin molded product is provided that includes a plurality of convex parts distributed in a predetermined area. A height of each of the plurality of convex parts is 2 μm or more and 15 μm or less. An arithmetic mean height of a profile in the predetermined area is 12 nm or more and 20 nm or less. The profile is obtained by removing height information of 1 μm or more from height information of the plurality of convex parts.

Further features of the present disclosure will become apparent from the following description of exemplary embodiments with reference to the attached drawings.

### BRIEF DESCRIPTION OF THE DRAWINGS

FIG. 1A is an enlarged perspective view schematically illustrating a part of an outer surface of a resin molded product according to an exemplary embodiment. FIG. 1B is a cross-sectional view taken along a line A1-A2.

FIG. 2 is a graph illustrating a bidirectional reflectance distribution function (BRDF) value of black color by coating.

FIGS. 3A and 3B are diagrams illustrating a principle for sensing black color.

FIG. 4A is a schematic perspective view illustrating an example of a mold for molding the resin molded product according to the exemplary embodiment. FIG. 4B is a schematic perspective view illustrating an example of the resin molded product according to the exemplary embodiment.

FIG. 5 is a diagram illustrating a method of manufacturing the mold by using a laser beam machine.

FIG. 6A is a diagram illustrating a setup of an injection molding apparatus. FIG. 6B is a diagram illustrating a mold clamping step. FIG. 6C is a diagram illustrating an injection step. FIG. 6D is a diagram illustrating a dwelling step and a cooling step. FIG. 6E is a diagram illustrating a mold opening step and a demolding step.

FIG. 7A is a graph illustrating a measurement value of the BRDF value of the resin molded product. FIG. 7B is an image illustrating height information on the resin molded product.

FIG. 8 is a cross-sectional view of the resin molded product.

FIG. 9A is an image illustrating extracted apices of convex parts of the resin molded product, and FIG. 9B is an image illustrating height information on high-frequency components of the resin molded product.

FIG. 10A is an appearance diagram of a camera including the resin molded product according to the exemplary embodiment, and FIG. 10B is an appearance diagram of a printer including the resin molded product according to the exemplary embodiment.

### DESCRIPTION OF THE EMBODIMENTS

In recent years, diversity is desired for product design. In particular, to improve the designability, a luxurious outer surface with deep black color is desired in some cases.

For example, to express luxurious deep black color by coating, a method of overpainting Japanese lacquer, or a method of expressing depth of black color by a plurality of layers of paints different in reflection and material is used. Further, a method of expressing deep black color by layering a plurality of substances different in reflectance to create a portion with strong light intensity and a portion with weak light intensity is known.

However, as described above, a processing method by coating is not necessarily suitable for mass production in terms of uniformity, variation, man-hour, productivity, cost, and the like.

The present disclosure is directed to a resin molded product that can realize luxurious colors without coating.

A resin molded product, a method of manufacturing the resin molded product, a mold, an apparatus including the resin molded product, and the like according to an exemplary embodiment of the present disclosure are described with reference to drawings.

Note that an appearance surface held by the resin molded product according to the exemplary embodiment described below is not limited to a surface exposed to an outside of a housing, an outer shell, and the like of the apparatus. Even if the surface is not constantly visually recognizable by a user, the surface that is visually recognizable, for example, when a door, a hatch, a lid portion, or the like of the apparatus is opened, is to be handled as the appearance surface in some cases. Therefore, in the following, a surface of a resin member or a resin product that may be visually recognized by the user is simply referred to as an “outer surface” in some cases.

In the drawings referred in the following description of the exemplary embodiment, elements denoted by the same reference numerals have the same function unless otherwise noted.

### Resin Molded Product

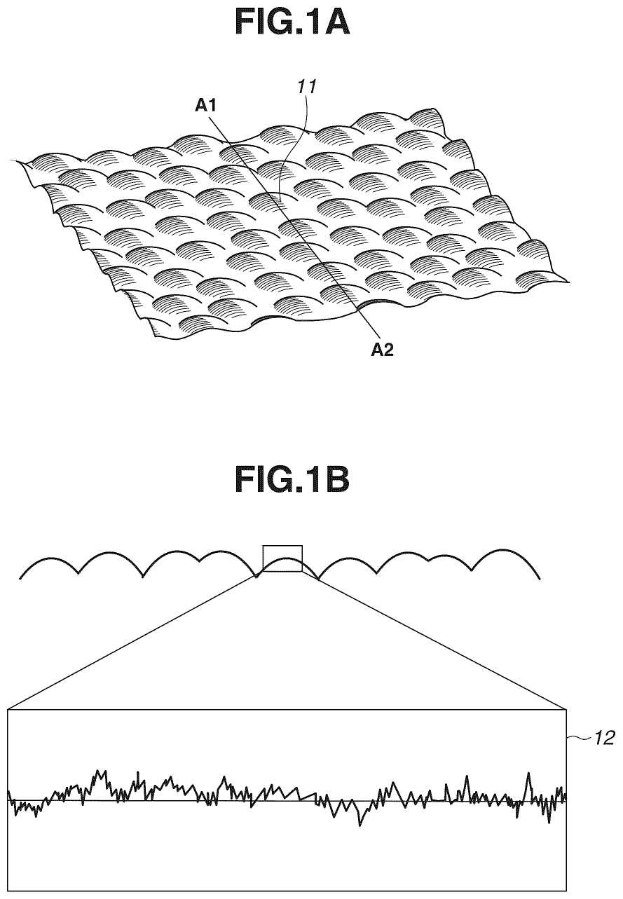

As for the resin molded product according to the exemplary embodiment, a shape of an outer surface as a predetermined area that causes an observer to sense luxurious colors without coating is described. FIG. 1A is an enlarged perspective view schematically illustrating a part of the outer surface (predetermined area) of the resin molded product according to the exemplary embodiment. FIG. 1B is a cross-sectional view illustrating a shape of the outer surface taken along a line A1-A2 in FIG. 1A. As illustrated in FIG. 1A and FIG. 1B, a large number of fine convex parts are provided on the outer surface of the resin molded product according to the exemplary embodiment.

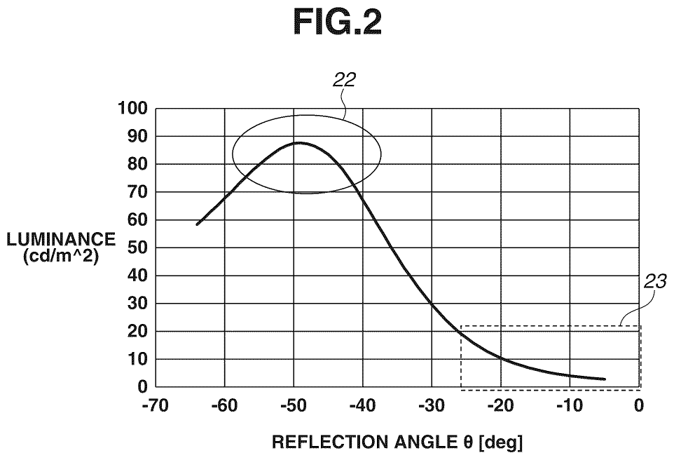

FIG. 2 is a graph illustrating a BRDF value of black color realized by coating. The BRDF indicates angle distribution characteristics of reflected light when light enters at a specific angle. The present exemplary embodiment is directed to reproduction of deep black color on a resin surface while suppressing glossiness caused by coating as illustrated in FIG. 2. In other words, the present exemplary embodiment is directed to reproduction of a BRDF value equivalent to the BRDF value of a coated surface that causes the observer to sense deep black color with suppressed glossiness, by processing a surface shape of a black-colored resin layer.

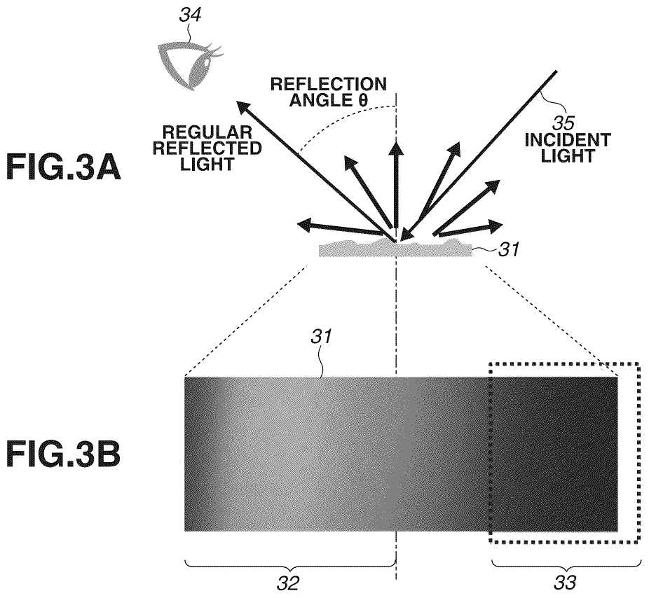

FIGS. 3A and 3B are diagrams illustrating a principle for sensing black color in visual recognition by a person. FIG. 3A illustrates a state where a molded product 31 is irradiated with incident light 35, and a person visually recognizes the molded product 31 from a place 34, i.e. location of viewing. FIG. 3B illustrates appearance of the molded product 31 viewed by the observer at the place 34.

An area 32 of the molded product 31 indicates an area where influence of regular reflected light of the incident light 35 is visually recognizable. An area 33 of the molded product 31 indicates an area where a reflection angle is −30 degrees or more and 0 degrees or less, separated from a regular reflection area of the incident light 35 (area where influence of regular reflection is little). In a case where the person determines colors of the molded product, the person does not determine colors based on one area of the molded product. The person visually recognizes a plurality of areas, in particular, both of an area with high gloss and an area with low gloss, and determines colors, namely, depth of black color in a case of black based on glossiness of these areas. In the example illustrated in FIG. 3B, when the observer views only the area 32 where the regular reflected light of the incident light 35 is visually recognizable, light reflection is strong, and therefore, the observer cannot determine black color of the molded product 31 only from the area 32. However, when glossiness of the area 33 separated from the area 32 where the regular reflected light of the incident light 35 is visually recognizable is made different from glossiness of the area 32, it is possible to cause the observer to recognize depth of black color. In other words, the surface is provided such that glossiness is different between the adjacent areas, which makes it possible to adjust the degree of black color in visual recognition.

In terms of the BRDF value, when a peak luminance 22 of the BRDF value in the regular reflection area 32 is suppressed, and a luminance 23 in the area 33 where the reflection angle is −30 degrees or more and 0 degrees or less is suppressed, the observer can sense deep black color (blackish color). In other words, when the peak luminance is 62 candela per square meter (cd/m²) or more and 112 cd/m² or less, and an average luminance in the area where the reflection angle is −30 degrees or more and 0 degrees or less is 10 cd/m² or more and 19 cd/m² or less, the surface can cause the observer to sense deep black with suppressed glossiness.

In the present exemplary embodiment, to reproduce such deep black with suppressed glossiness, a concave-convex structure is provided in a predetermined area on the surface of the resin molded product. Such a concave-convex structure on the surface of the resin molded product can be formed by, for example, providing a fine pattern (concave-convex pattern) on a surface of a mold (casting mold or press mold) and transferring the pattern on the surface of the mold to the molded product.

The present disclosure indicates that such a peak luminance can be adjusted by controlling a structure in several tens μm order of the concave-convex structure of the resin molded product, and the average luminance in the area where the reflection angle is −30 degrees or more and 0 degrees or less can be adjusted by controlling a structure of less than 1 μm.

More specifically, the concave-convex structure of the resin molded product may be provided such that an average interval between apices of a plurality of convex parts 11 distributed in the predetermined area becomes 20 μm or more and 60 μm or less, and a height of each of the plurality of convex parts 11 becomes 2 μm or more and 15 μm or less, as represented by an arithmetic mean height Sa, which is preferably 2.0 μm or more and 3.0 μm or less.

When such a range is satisfied, the peak luminance can be adjusted to 62 cd/m² or more and 112 cd/m² or less. At this time, when the average interval is less than 20 μm, the convex parts excessively overlap with each other, and the shapes of the convex parts cannot be maintained, which is not preferable. When the average interval exceeds 60 μm, the entire surface of the resin molded product cannot be covered with the convex parts, the original surface of the resin molded product is exposed, and the peak luminance value of gloss causing sense of block color is out of a specified range, which is not preferable.

Next, the structure of less than 1 μm of the concave-convex structure of the resin molded product is described. An enlarged area 12 illustrated in FIG. 1B indicates a surface roughness of high-frequency components present in one convex part 11 of the concave-convex structure of the resin molded product. The surface roughness of the high-frequency components is obtained by removing a profile in micron order from an entire profile of a cross-section in FIG. 1B taken along line A1-S2. For example, the surface roughness of the high-frequency components is a surface roughness of a profile in which height information of 1 μm or more is removed from the height information on the plurality of convex parts 11 of the resin molded product according to the present exemplary embodiment.

The arithmetic mean height Sa of the high-frequency components of the concave-convex structure of the resin molded product is 12 nm or more and 20 nm or less. When the arithmetic mean height Sa of the high-frequency components is provided in such a manner, the average luminance in the area where the reflection angle is −30 degrees or more and 0 degrees or less can be adjusted to 10 cd/m² or more and 19 cd/m² or less.

The concave-convex structure may be formed such that a curvature is substantially equal among the convex parts of the resin molded product. When the curvature is made equal among the convex parts, light reflection states can be aligned, and the colors of the entire appearance of the resin molded product can be uniformized.

When the surface of the resin molded product is formed in such a shape, a luxurious appearance structure of deep black with suppressed glossiness can be realized without coating.

### Mold

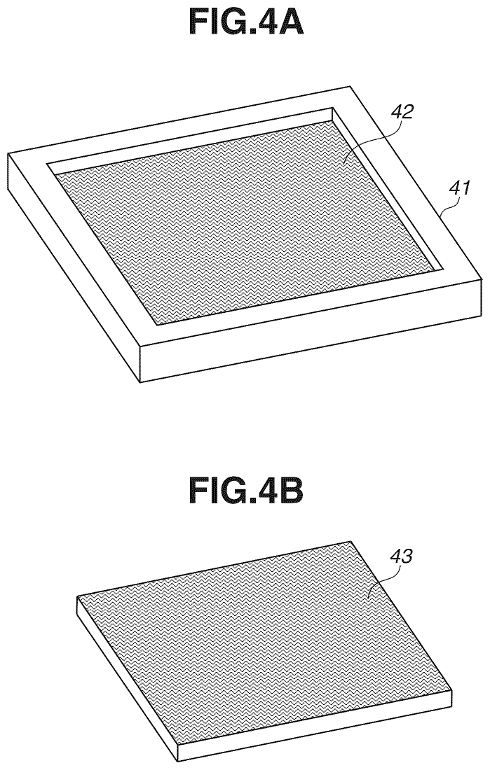

FIG. 4A is a schematic perspective view illustrating an example of a mold for molding the resin molded product according to the exemplary embodiment. FIG. 4B is a schematic perspective view illustrating an example of the resin molded product according to the exemplary embodiment. In a surface area 42 of a mold 41 for the resin molded product, a structure that enables molding of a desired appearance structure by transferring the structure of the mold surface to a resin material is formed. When the structure of the surface area 42 of the mold 41 is transferred to a surface of the resin material, a resin molded product 43 having the desired appearance structure can be obtained.

Transfer molding of the mold surface may be performed by an optional transfer method such as roll molding or press molding, in addition to injection molding. In the example illustrated in FIG. 4B, the resin molded product 43 is illustrated as a flat plate member having a rectangular shape; however, the resin molded product 43 can be formed to have a thin flat plate shape such as a sheet or a film, a bent shape, and a curved surface shape. For example, as the resin material of the resin molded product 43, a thermoplastic material such as polyethylene, polystyrene, polypropylene, polyvinyl chloride, polyester, polyamide, and polycarbonate can be used. Further, as the resin material of the resin part, a high-strength resin containing glass filler, carbon filler, or the like, or a conductive resin can be used as long as the resin material is an opaque material.

### Method of Manufacturing Mold

Next, an example of a method of manufacturing the mold used to manufacture the resin molded product according to the present exemplary embodiment is described.

As a material of the mold, a material suitable to transfer a fine shape to a resin with high reproducibility, for example, stainless steel and aluminum can be used. In the present exemplary embodiment, a metal mold is described; however, the mold may not be made of a metal as long as the fine shape can be transferred to the resin with high reproducibility. In a mold surface of the mold, concave parts (reversed mold) for forming the concave-convex surface reproducing the above-described black color on the resin molded product by transfer is formed. Such concave parts can be formed by cutting, blasting, etching, or the like in principle; however, to form the fine concave parts with high accuracy in a short time, laser processing is particularly suitable.

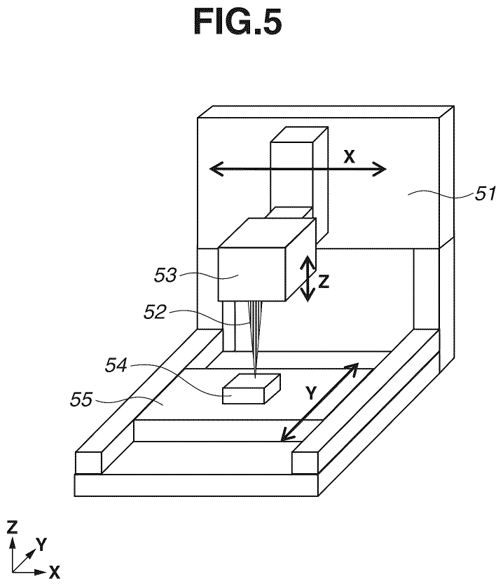

FIG. 5 is a diagram illustrating the method of manufacturing the mold according to the exemplary embodiment by using a laser beam machine. A laser beam machine 51 includes a laser head 53 that can perform irradiation of a processing laser beam 52, and a processing stage 55 on which a mold block 54 as a workpiece can be placed. The relative position of the laser head 53 and the mold block 54 can be changed by an X-axis moving mechanism, a Y-axis moving mechanism, and a Z-axis moving mechanism, and an optional position of the mold block 54 can be irradiated with the processing laser beam 52.

The laser beam emitted from the laser head 53 is converged by an optical system (not illustrated), and is condensed on a predetermined focal position. Therefore, when a processing area is irradiated with the laser beam, each of the axis moving mechanisms is driven such that a state is maintained where the laser head 53 and an irradiated point are constantly separated by a focal length. In addition, as one method of reducing irradiation energy density in order to control a processing shape (e.g., curvature and depth of concave part), laser irradiation may be performed while maintaining a defocused state in which a distance between the laser head 53 and the irradiated point is shifted by a predetermined distance from the focal length.

A two-axis galvano scanner and a fθ lens are incorporated in the laser head 53. Driving a galvano mirror makes it possible to scan an irradiation position at high speed. Scanning by the galvano mirror can be performed at high speed as compared with a case where the stage is driven. Therefore, control of the irradiation position by using not only movement of the stage but also scanning by the galvano mirror is advantageous for reduction in processing time.

As a laser light source for laser processing, a continuous wave (CW) laser performing continuous irradiation, or a pulse laser that repeats irradiation in a short time can be used. In the present exemplary embodiment, a laser light source having a pulse width of nanosecond is suitably used. A laser for which conditions such as irradiation intensity of a laser, a pulse length, and a pulse interval are optionally selectable may be used. For example, as a laser oscillator, a nanosecond pulse laser manufactured by Amplitude Systems can be used.

In the exemplary embodiment, a wavelength of the processing laser generated by the nanosecond pulse laser oscillator is set to 1030 nm, its pulse width is set to 30 nanoseconds, and its average output is set to 15 W.

Such a laser beam machine is used, an irradiation condition is set based on the shape, and laser irradiation is performed on the area of the mold surface while scanning with the laser. As a result, a large number of concave parts can be formed on the mold surface.

### Method of Manufacturing Resin Molded Product

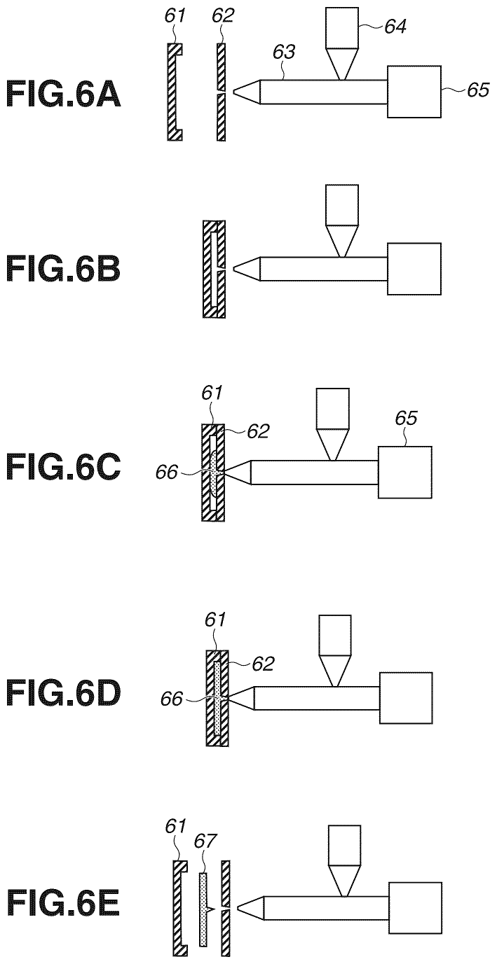

Next, a method of manufacturing a resin molded product having the resin surface that causes the observer to sense deep black with suppressed glossiness, by using the mold provided by the above-described method is described. FIGS. 6A to 6E are schematic diagrams illustrating manufacturing steps when the resin molded product according to the exemplary embodiment is manufactured using an injection molding apparatus.

FIG. 6A is a schematic diagram illustrating a setup of the injection molding apparatus, and illustrates molds 61 and 62, a cylinder 63 for injecting a resin into the molds, and a hopper 64 for putting the resin material in the cylinder 63. In the present exemplary embodiment, as a colorant of the resin material, black-colored polycarbonate that contains about 30% of glass filler available from TEIJIN LIMITED is added. Therefore, the resin material is colored with black color.

A screw (not illustrated) is provided inside the cylinder 63. When the screw is rotated by a motor 65, the resin material is fed to a front end of the cylinder 63. In addition, a heater (not illustrated) is provided in the cylinder 63. The resin material in a solid state put from the hopper 64 is heated to a melting temperature or more and is molten in the middle of being fed to the front end of the cylinder 63, and the molten resin material is stored in a space at the front end of the cylinder 63.

Thereafter, a mold clamping step illustrated in FIG. 6B is performed. The mold 61 and the mold 62 are aligned by a movable mechanism (not illustrated), and are closed to form a cavity. The mold 61 and the mold 62 are heated by a heater (not illustrated). Generally, a flow path through which high-temperature liquid flows is formed inside the molds, and a flow rate and a temperature of the liquid are controlled to adjust a temperature of the molds. A heating temperature of the molds in this step is referred to as a mold temperature.

Subsequently, an injection step illustrated in FIG. 6C is performed. A nozzle at the front end of the cylinder 63 is pressed against an injection hole part provided in the mold 62. When the motor 65 further operates to rotate the screw (not illustrated), a molten resin 66 is injected into the cavity formed by the mold 61 and the mold 62. A temperature of the molten resin in this step is referred to as a resin temperature.

Subsequently, a dwelling step and a cooling step illustrated in FIG. 6D are performed. In the dwelling step, pressure applied to the molten resin 66 having injected into the cavity is maintained at predetermined pressure by controlling hydraulic pressure inside the cylinder 63. The predetermined pressure is referred to as dwelling pressure. As the dwelling pressure, pressure spreading the molten resin 66 to corners of a space inside the cavity is selected.

In the cooling step subsequent to the dwelling step, the mold 61 and the mold 62 are cooled by a cooling mechanism (not illustrated) while being arranged as illustrated in FIG. 6D, and the resin inside the cavity is cooled to a glass transition point temperature or less and is solidified. As the cooling mechanism, for example, a system in which a flow path of refrigerant is disposed around the molds, and the refrigerant is circulated to cool the molds can be used.

After the resin inside the cavity is solidified, a mold opening step and a demolding step illustrated in FIG. 6E are performed. First, in the mold opening step, the mold 61 and/or the mold 62 are moved and separated from each other by a driving mechanism (not illustrated).

In the subsequent demolding step, for example, a resin molded product 67 adhering to one of the molds is separated from the mold and taken out by projecting an ejector pin (not illustrated). As necessary, a gate mark (burr remaining on position of injection gate) formed on the taken-out resin molded product 67 may be removed.

By the manufacturing method described above, the resin molded product can be obtained.

### Evaluation Method

Next, a method of evaluating the manufactured resin molded product is described.

The BRDF value of the molded product was measured using Gonio-Spectrophotometric Color Measurement System GCMS11 manufactured by Murakami Color Research Laboratory. A height of each of convex parts of the molded product was measured using a shape analysis laser microscope VK-X series manufactured by KEYENCE CORPORATION.

In a first exemplary embodiment, a mold manufactured by the above-described method of manufacturing the mold was used, a resin molded product was manufactured by the above-described method of manufacturing the resin molded product, and the height of each of the convex parts and the BRDF value of the resin molded product were measured using the above-described evaluation method.

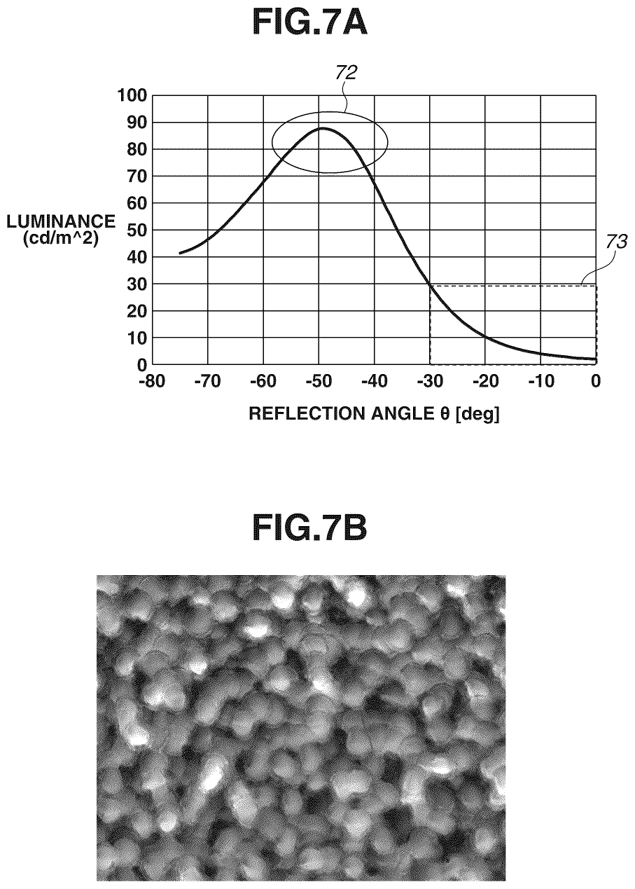

FIG. 7A is a graph illustrating data on the resin molded product measured using Gonio-Spectrophotometric Color Measurement System CGMS11. An X-axis indicates a reflection angle, and a Y-axis indicates a luminance. From a measurement result, a peak luminance 72 was 87.8 cd/m², and an average luminance 73 in the area where the reflection angle is −30 degrees or more and 0 degrees or less was 11.5 cd/m².

FIG. 7B is monochromatic image data on height information on the resin molded product measured by the laser microscope VK-X series using a 20× microscope lens. A white portion was a high portion in the shape of the molded product, and a black portion is a low portion in the shape of the molded product. A surface was analyzed using bundled software of the laser microscope manufactured by KEYENCE CORPORATION, and an arithmetic mean height Sa was 2.5 μm.

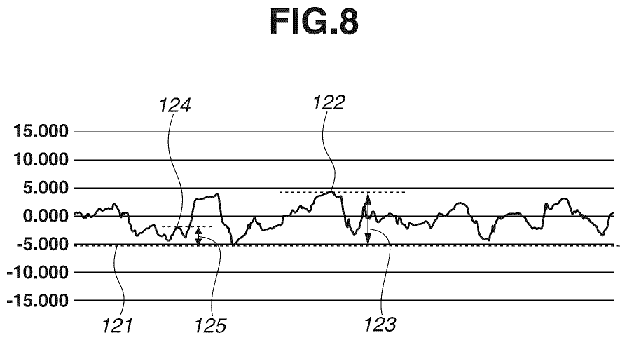

FIG. 8 is a cross-sectional view of the resin molded product manufactured in the present exemplary embodiment. Height information on a profile was acquired using bundled software of the laser microscope manufactured by KEYENCE CORPORATION. A height 125 of the lowest convex part was 3 μm, and a height 123 of the highest convex part was 9.5 μm. In FIG. 8, a dashed line 121 indicates the lowest part, a dashed line 122 corresponds to the highest convex part relative to the part illustrated by the dashed line 121, and the height 123 indicates the height of the highest convex part. A dashed line 124 indicates the lowest convex part, and the height 125 indicates the height of the lowest convex part.

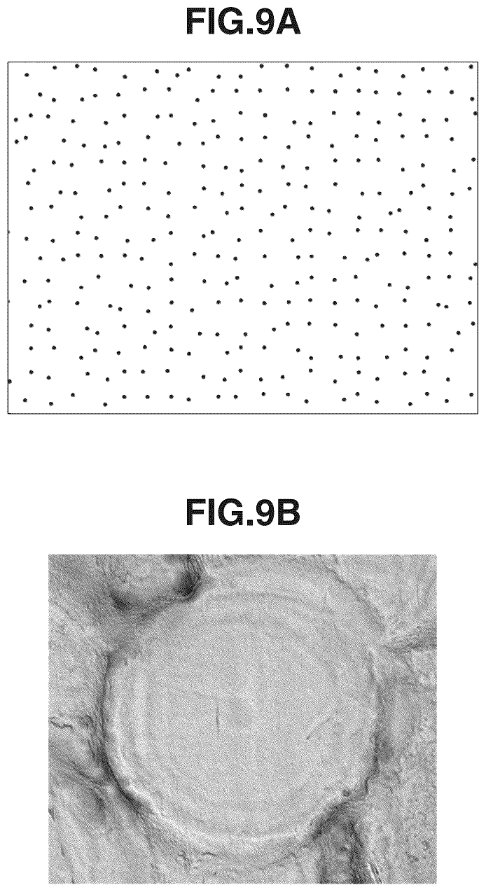

FIG. 9A is an image obtained by observing the surface of the resin molded product manufactured in the present exemplary embodiment by the laser microscope, extracting apex information on the convex parts from the data, and converting the apices into points. The apices were extracted using bundled software of the laser microscope manufactured by KEYENCE CORPORATION, and an average interval was calculated to be 30 μm.

FIG. 9B illustrates a state where the surface of the resin molded product manufactured in the present exemplary embodiment is observed by the laser microscope. In FIG. 9B, high-frequency components were extracted from data measured by a laser microscope VK-X series using a 200× microscope lens, by using bundled software of the laser microscope manufactured by KEYENCE CORPORATION. An arithmetic mean height Sa of the high-frequency components was calculated to be 0.015 μm.

When the resin molded product prepared in the present exemplary embodiment was visually observed, the resin molded product realized deep black color with suppressed glossiness, and had a luxurious appearance comparable to a coated product coated with Japanese lacquer or a plurality of paint layers.

### Other Exemplary Embodiments

The present disclosure is not limited to the above-described exemplary embodiment, and can be variously modified and combined within the technical idea of the present disclosure.

For example, the manufacturing method is not limited to the above-described injection molding method, and the resin molded product can be manufactured by various types of transfer molding methods of transferring the shape of the mold surface to the resin material. For example, the concave-convex structure can be formed on the surface of the resin by an appropriate transfer method such as roll molding or press molding.

The resin molded product according to the present exemplary embodiment is not limited to the example illustrated in FIGS. 4A and 4B. According to the exemplary embodiment, luxurious colors can be imparted to a resin molded product having various forms and functions.

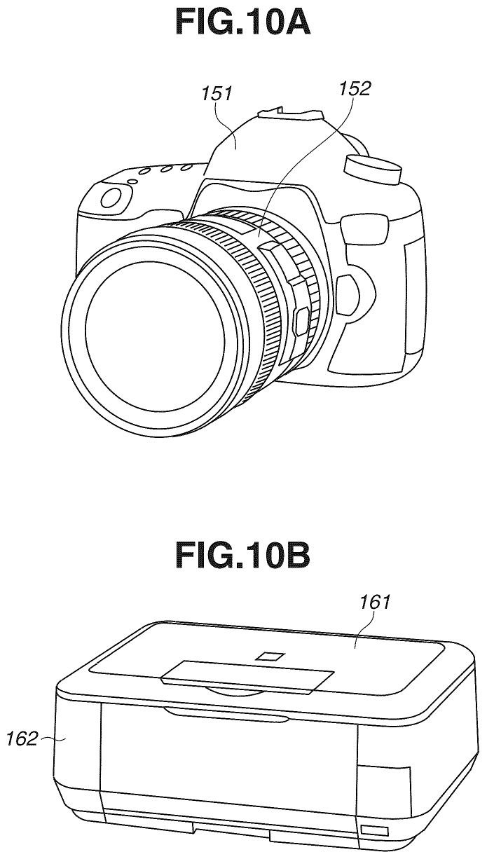

For example, luxurious colors can be imparted to a surface of an exterior part 151 of a camera body, a surface of an exterior part 152 of a lens barrel, and the like of a camera illustrated in FIG. 10A. Alternatively, for example, luxurious colors can be imparted to a surface of an exterior part 161 of a top board, a surface of an exterior part 162 of a side surface, and the like of a printer illustrated in FIG. 10B. The camera is not limited to the example illustrated in FIG. 10A, and may be a lens-interchangeable single-reflex camera, a mirrorless camera, a compact camera, or a smartphone including an imaging function. The printer is not limited to the example illustrated in FIG. 10B, and may be various forms such as a printing-dedicated apparatus, a copier, and a multifunctional peripheral having a reading function, and the recording system may be an electrophotographic system, an inkjet system, or a heat transfer system, and is not particularly limited.

A surface of a product to which the present exemplary embodiment is applied is not limited to a flat surface, and the present exemplary embodiment is applicable to a surface subjected to surface treatment for enhancing grip force (knurling treatment). In this case, the shape of the concave-convex structure of the resin molded product may be provided according to the present exemplary embodiment so as to satisfy the above-described condition in a state where the shape derived by the knurling treatment is eliminated. In other words, in a case where a resin molded product is provided on a surface of a part having a concave-convex pattern of about 1 mm generated by the knurling treatment, the surface having the concave-convex pattern of about 1 mm generated by the knurling treatment is used as a reference surface. Further, the resin molded product is provided on the reference surface such that a height of each of a plurality of convex parts of the resin molded product becomes 2 μm or more and 15 μm or less, and an arithmetic mean height Sa of high-frequency components in the above-described predetermined area becomes 12 nm or more and 20 nm or less. This makes it possible to achieve similar effects.

Further, the present exemplary embodiment can be applied not only to a resin molded product of a camera and a printer, but also to a resin molded product causing an observer to visually recognize luxurious colors, such as an interior part of an automobile or an outer box of cosmetics. The resin molded product may have a thin flat plate shape such as a sheet or a film, or a three-dimensional shape including a curved surface, or may have flexibility.

As a main component of the resin material used for the resin molded product, for example, a thermoplastic resin such as polyethylene, polystyrene, polypropylene, polyvinyl chloride, polyester, polyamide, or polycarbonate can be suitably used, but the main component of the resin material is not limited thereto. The exemplary embodiment may be applied to a high-strength resin obtained by adding glass filler or carbon filler to a resin, or a functional resin such as a conductive resin.

In the present exemplary embodiment, the resin molded product that is formed using the black-colored resin material in order to achieve color depth is described; however, the present exemplary embodiment is not limited to black color. Using a similar technique for colors other than black color makes it possible to achieve color depth.

When an appropriate pigment and the like is contained in the resin material, optional color can be added to the resin.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2024-026812, filed Feb. 26, 2024, and No. 2024-217433, filed Dec. 12, 2024, which are hereby incorporated by reference herein in their entirety.

What is claimed is:

1. A resin molded product, comprising:
a plurality of convex parts distributed in a predetermined area,
wherein a height of each of the plurality of convex parts is 2 μm or more and 15 μm or less, and
wherein an arithmetic mean height of a profile in the predetermined area is 12 nm or more and 20 nm or less, the profile being obtained by removing height information of 1 μm or more from height information of the plurality of convex parts.

2. The resin molded product according to claim 1, wherein the profile is present in at least one convex part of plurality of convex parts.

3. The resin molded product according to claim 1, wherein the resin molded product is formed from a black-colored resin material.

4. The resin molded product according to claim 1, wherein, as a bidirectional reflectance distribution function value in the predetermined area, a peak luminance is 62 cd/m² or more and 112 cd/m² or less, and an average luminance in an area where a reflection angle is −30 degrees or more and 0 degrees or less is 10 cd/m² or more and 19 cd/m² or less.

5. The resin molded product according to claim 1, wherein an average interval between the plurality of convex parts is 20 μm or more and 60 μm or less.

6. The resin molded product according to claim 1, wherein an arithmetic mean height of the plurality of convex parts in the predetermined area is 2.0 μm or more and 3.0 μm or less.

7. The resin molded product according to claim 1, wherein each part of the plurality of convex parts has a curvature that is substantially equal to a curvature of each other part of the plurality of convex parts.

8. The resin molded product according to claim 1, wherein the resin molded product is provided on a surface of a concave-convex structure.

9. A mold comprising, a molding surface including a plurality of concave parts configured to mold the plurality of convex parts of claim 1.

10. A method of manufacturing the resin molded product according to claim 1 by a transfer molding using a mold.

11. A camera comprising the resin molded product according to claim 1.

12. A printer comprising the resin molded product according to claim 1.
